(19) United States
(12) Patent Application Publication
(10) Pub. No.: US 2003/0191859 A1
(43) Pub. Date: Oct. 9, 2003

(54) Fast remote display of images using compressed XPutImage

(76) Inventor: Paul R. Ramsey, Tucson, AZ (US)

Correspondence Address: Jeffrey C. Hood, Conley, Rose, & Tayon, P.C., P.O. Box 398, Austin, TX, 78767, US

(21) Appl. No.: 10/117,447

(22) Filed: Apr. 5, 2002

(51) Int. Cl. G06F 15/16

(52) U.S. Cl. 709/247

(57) ABSTRACT

A system and method for transferring a compressed image from a local computer system to a remote computer system, and inducing image decompression and display at the remote computer system. A user of the local computer system invokes a software application on the local computer system. The application compresses an image, and calls an X extension function to induce transfer of a data stream containing the compressed image to a remote X Server executing on a remote computer system. The remote X Server receives the data stream, and invokes an executable code corresponding to the X extension function in response to receiving the data stream. The executable code controls the decompression of the compressed image, and calls a standard X internal PutImage operation to display the decompressed image on a display associated with the remote computer system.

### BACKGROUND OF THE INVENTION

1. Field of the Invention

This invention relates generally to the field of telecommunication and, more particularly, to a system and method for more effectively transferring image data across a network.

2. Description of the Related Art

Many software applications make use of the X Window system to display images on display devices. In particular, the X Window system and Xlib library have a function called XPutImage for displaying images. For more information on the XPutImage function, please refer to pages 478-479 of

“Xlib Reference Manual”, Volume Two, Third Edition, ISBN 1-56592-006-6, edited by Adrian Nye, published by O'Reilly & Associates, Inc.

Since X uses a network protocol, an X server can be local to the machine an application is running on or on a remote machine. Using standard X, each pixel of an image may require 4 bytes each. Thus, sending a fall screen 1280×1024 image may require 5 megabytes of data. It would be convenient to have a way to send images within the X framework using compression. Furthermore, there exists a need for a system and methodology which would allow a software application to rapidly display images on a remote X display without requiring a special client program.

### SUMMARY OF THE INVENTION

In one set of embodiments, a method for transferring a compressed image from a local computer system to a remote computer system, and inducing image decompression and display at the remote computer system may be arranged as follows. A user of the local computer system invokes a software application on the local computer system. The application compresses an image, and calls an X extension function to induce transfer of a data stream containing the compressed image to a remote X Server executing on a remote computer system.

The remote X Server receives the data stream, and invokes an executable code corresponding to the X extension function in response to receiving the data stream. The executable code controls the decompression of the compressed image, and calls a standard X internal PutImage operation to display the decompressed image on a display associated with the remote computer system.

Rather than sending an image as raw uncompressed pixels, the image is sent in compressed form but otherwise displayed in the same way as with the standard XPutImage.

The X extension may not do the compression because there are often opportunities for local graphics accelerator hardware to do at least part of the compression or the application will often have prior knowledge of the contents of the image to make compression easier.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates a local computer system and a remote computer system coupled through a computer network;

FIG. 2 illustrates one embodiment of a method for arranging the transfer of compressed images to a remote computer system with image decompression and display to be performed at the remote computer system;

FIG. 3 illustrates a set of two or more computers coupled through a computer network; and

FIG. 4 illustrate one set of embodiments of a method for transferring a compressed image from a local computer system to a remote computer system, and inducing image decompression and display at the remote computer system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

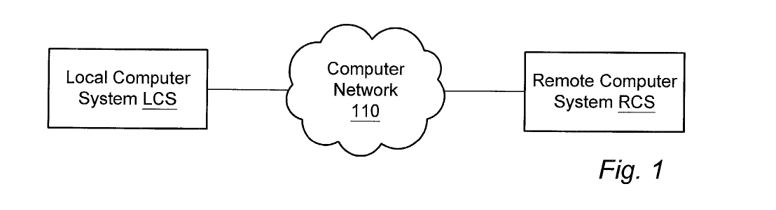

In one set of embodiments, a local computer system LCS and a remote computer RCS may be coupled through a computer network 110 as suggested by FIG. 1. For example, each computer system may have a network interface card to facilitate communication through the computer network 110. The computer network 110 may be a local area network, a wide area network, or a global network such as the Internet).

An application running on the local computer system LCS may generate (or access) an image, and call an XPutImage function to induce (a) transmission of the image to the remote computer system RCS through the computer network and (b) display of the image on a display associated with the remote computer system. An XServer running on the remote computer system (associated with the remote display) receives a protocol data stream (containing the image) in response to the XPutImage function call, and invokes the XPutImage executable code to display the image.

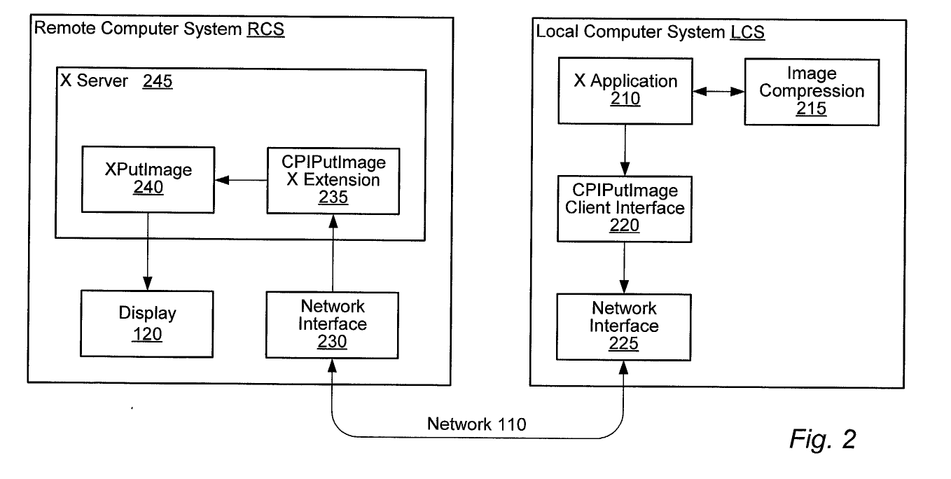

Because transmission bandwidth through the computer network 110 may be a limited resource, it may be desirable to send the images in compressed form. Unfortunately, the standard XPutImage code at the remote X server does not support image decompression. Thus, an X extension may be configured to allow transmission of compressed images as suggested by FIG. 2.

An X application 210 (i.e. any software application which is configured to make calls to X) running on the local computer system LCS may generate an image (or receive an image, or read an image from a memory, etc.), and call an image compression algorithm 215 to compress the image. After compressing the image, the X application may call a function CPIPutImage to induce transmission of the compressed image across the network to the remote X Server 245. The call to CPIPutImage invokes a client interface 220 which handles the transmission of the compressed image through the computer network 110 to the X Server 245. Local computer system LCS includes a network interface 225, and remote computer system RCS includes a network interface 230. The network interfaces represent any software and/or hardware required for communicating through computer network 110.

The remote X Server 245 receives a protocol data stream (containing the compressed image), and invokes the executable code 235 for the X extension function CPIPutImage in response to receiving the protocol data stream. The CPIPutImage function decompresses the compressed image (e.g. by calling a decompression algorithm which is complementary to the compression algorithm 215), and calls the executable code 240 for the standard X internal PutImage operation to display the decompressed image.

The X extension allows applications to remotely display images by calling the function CPIPutImage which has an interface very similar to the XPutImage function, except that each image is provided to the CPIPutImage function in compressed form. The extension includes the following functions:

| int CPIQueryVersion(Display* dpy) | |
|---|---|
| int CPIPutImage( | Display* dpy, |
| | Drawable d, |
| | GC gc, |
| | int destx, |
| | int desty, |
| | unsigned int width, |
| | unsigned int height, |
| | int format, |
| | unsigned char* data, |
| | unsigned int length) |

The variables dpy, d, gc, destx, desty, width, and height are identical to the corresponding variables defined for the XPutImage function. The variable format is a number identifying the compression format to be used. The variable data is a pointer to the compressed data. The variable length is the length in bytes of the compressed data.

The X extension 235 which runs in the X server 245 is quite simple. It receives the compressed data, decompresses the compressed data, and then calls the standard X internal PutImage operation 240 (already included in the X server) to display the decompressed image. By storing the appropriate state information in the extension, the extension may support interframe decompression.

The value of this extension is that with the extension in place, it isn't necessary for a separate application to be running on the remote computer system RCS to be able to rapidly display images over the network. This makes it easy to implement on a variety of platforms as long as the platforms support the X window system protocol and allow for extensions.

When used in conjunction with a network appliance (e.g. a SunRay™), the X extension may forward the data to the appliance without decompression. Thus, the appliance may perform the decompression.

Any of a variety of codecs (compression/decompression algorithms) may be used to compress/decompress the image data. In one embodiment, the extension may use the codec disclosed in U.S. patent application Ser. No. 09/779,333 entitled “Entropy coding using Adaptable Prefix Codes”, filed on Feb. 8, 2001, invented by Russ Brown. This patent application is herein incorporated by reference in its entirety.

The variable format allows for the selection of a codec from a set of stored codecs.

In some embodiments, one value of the variable format may be use to indicate that the image being passed to the CPIPutImage function has not been compressed.

It is noted that the X application 210 may be configured to generate (or access) a sequence of images, each of which is to be displayed on the remote display (at the remote computer system). Thus, the X application 210 may perform the compression operation and the call to the CPIPutImage function for each image in the image sequence.

The X application 210 may generate the image which is to be remotely displayed. For example, in one embodiment, the X application may be a graphics application configured to generate the image by asserting rendering commands through a graphics API (application programmer's interface) such as OpenGL.

In another embodiment, the X application 210 may access the image from a memory medium (such as random access memory, read only memory, CD-ROM, magnetic tape, magnetic disk, or any combination thereof).

In yet another embodiment, the X application 210 may receive the image from a video capture device coupled to a video camera.

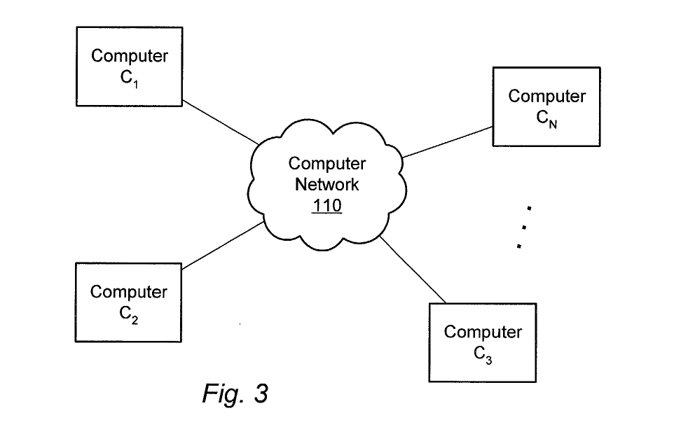

In one set of embodiments, a set of computer systems C₁, C₂, . . . , C_{N} may be coupled through a computer network 110 (e.g. a local area network, wide area network, or the Internet), where N is an integer greater than or equal to two, as suggested by FIG. 3. An application running on any computer system C_{I} of the N computer systems may remotely display images on any other computer system C_{J} of the N computer systems (i.e. I not equal to J) by the system and methodology described above. Furthermore, an application running on computer system C_{J} may remotely display images on computer system C_{I} may the same mechanism.

In one embodiment, computer system C_{I} may display remotely on two or more of the N computer systems by calling the CPIPutImage function two or more times respectively.

The present invention contemplates storage media for storing the X extension code and/or the client interface disclosed herein. Any of a variety of storage media are contemplated including CD-ROM, semiconductor read-only memory (ROM) and/or random access memory (RAM), magnetic disk, magnetic tape, bubble memory.

As disclosed in the various embodiments described herein, an X extension may be configured to support the rapid transfer and display of images on a remote system by allowing the images to be sent in compressed form with the X extension doing the decompression once the image has been sent.

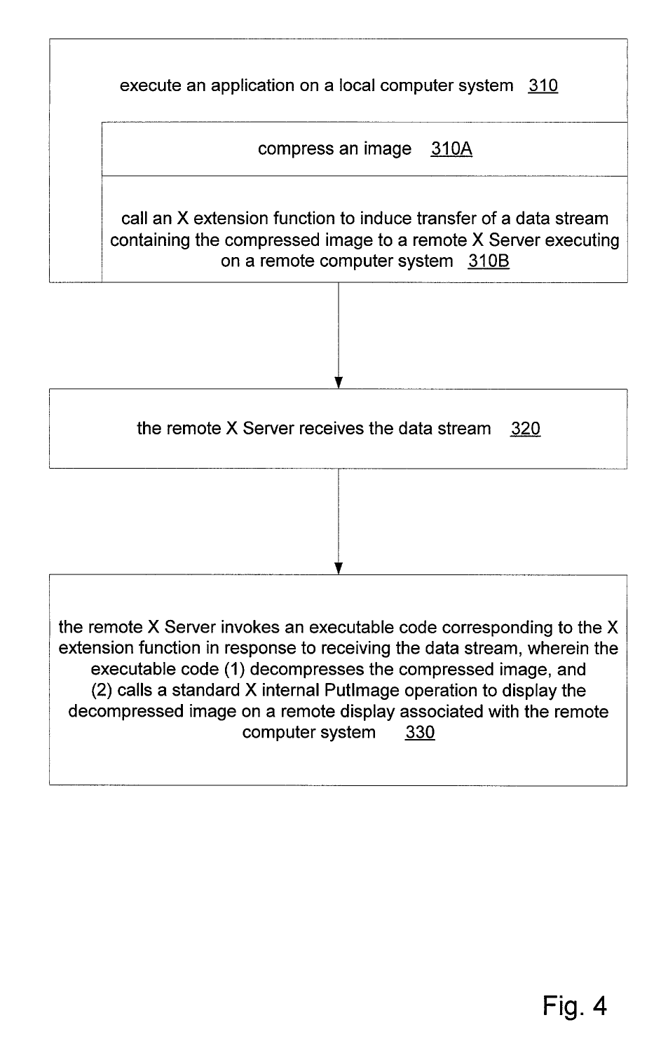

FIG. 4 illustrates one set of embodiments of a method for transferring a compressed image from a local computer system to a remote computer system, and inducing image decompression and display at the remote computer system.

In step 310, a user of the local computer system invokes a software application on the local computer system. The application compresses an image as indicated in step 310A, and calls an X extension function (e.g. the CPIPutImage function described above) to induce transfer of a data stream containing the compressed image to a remote X Server executing on a remote computer system as indicated in step 310B.

In step 320, the remote X Server receives the data stream, and invokes an executable code corresponding to the X extension function in response to receiving the data stream, as indicated in step 330. The executable code controls the decompression of the compressed image, and calls a standard X internal PutImage operation to display the decompressed image on a display associated with the remote computer system.

The application's calling of the X extension function may invoke the execution of a client interface on the local computer system. The client interface handles the transmission of the data stream to the X Server.

The local computer and the remote computer are coupled through a computer network. The application's calling of the X extension function induces the transfer of the data stream to the remote X Server through the computer network. Each computer may have a network interface card and software to support transfer through the network.

The software application may call the X extension function one or more additional times to induce transfer of one or more additional data streams respectively, each containing the compressed image, to one or more additional remote X Servers executing on one or more additional remote computers respectively. In other words, the local computer system may transfer to multiple remote computer systems.

Furthermore, the software application may generate (or access) a sequence of images. Thus, the image compression and the call (or calls) to the X extension function may be performed repeatedly, i.e. once for each image in the image sequence.

It is noted that an X Server running on the local computer system may be similarly extended. Thus, an application executing on the remote computer system may generate (or access an image), compress the image, and induce transfer of the compressed image to the X Server at the local computer system. The X server at the local computer system invokes extension code corresponding to the X extension function to perform image decompression and display of the decompressed image at the local computer system.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

What is claimed is:

1. A method comprising:
executing an application on a first computer system, wherein said executing comprises:
(a) compressing an image, and
(b) calling an X extension function to induce transfer of a data stream containing the compressed image to a remote X Server executing on a second computer system;
the remote X Server receiving the data stream, and invoking an executable code corresponding to the X extension function in response to receiving the data stream, wherein the executable code:
(c) decompresses the compressed image, and
(d) calls a standard X internal PutImage operation to display the decompressed image on a remote display associated with the second computer system.

2. The method of claim 1, wherein said calling the X extension function invokes the execution of a client interface on the first computer system, wherein the client interface handles the transmission of the data stream to the X Server.

3. The method of claim 1, wherein the first computer and second computer are coupled through a computer network, wherein said calling the X extension function induces transfer of the data stream to the remote X Server through the computer network.

4. The method of claim 1, wherein the executable code decompresses the compressed image by calling a decompression algorithm.

5. The method of claim 1, wherein said executing the application further comprises:
calling the X extension function one or more additional times to induce transfer of one or more additional data streams respectively, each containing the compressed image, to one or more additional remote X Servers respectively, executing on one or more additional computers respectively.

6. The method of claim 5, wherein each of the remote X Servers is configured to receive the corresponding data stream, and invoke an executable code corresponding to the X extension function, wherein the executable code:
decompresses the compressed image, and
calls a standard X internal PutImage operation to display the decompressed image on a remote display associated with the corresponding additional computer.

7. The method of claim 1, wherein said executing the application comprises repeatedly performing (a) and (b) for a sequence of images.

8. The method of claim 1, wherein said executing the application further comprises generating the image.

9. The method of claim 1 further comprising executing a second application on the second computer system, wherein said executing comprises:
compressing a second image, and
calling the X extension function to induce transfer of a second data stream containing the compressed second image to a second X Server executing on the first computer system.

10. The method of claim 9, wherein the second X Server receives the second data stream, and invokes an executable code corresponding to the X extension function, wherein the executable code:
decompresses the compressed second image, and
calls the standard X internal PutImage operation, of the second X Server, to display the decompressed image on a display associated with the first computer system.

11. A memory medium configured to store program instructions, wherein the program instructions define an X extension to an X Server, wherein the program instructions are executable by a first computer to implement:
decompressing a compressed image, and
calling a standard X internal PutImage operation to display the decompressed image on a display associated with the first computer system;
wherein the compressed image is received by the X Server from a second computer in response to a call to an X extension function, corresponding to the X extension, asserted by an application running on the second computer.

12. A computer system comprising:
a memory configured to store program instructions; and
a processor configured to read and execute the program instructions, wherein the program instructions define an X extension to an X Server, wherein the program instructions are executable by a processor to implement:
decompressing a compressed image, and
calling a standard X internal PutImage operation to display the decompressed image on a display associated with the second computer system;
wherein a data stream containing the compressed image is received by the X Server from a remote computer in response to a call to an X extension function, corresponding to the X extension, asserted by an application running on the remote computer.

13. A communication system comprising:
a first computer system configured to execute an application;
a second computer system configured to execute an X Server corresponding to a display associated with the second computer system;
wherein in response to execution of the application, the first computer system is configured to:
(a) compress an image, and
(b) call an X extension function to induce transfer of a data stream containing the compressed image to the X Server executing on the second computer;
wherein the X Server executing on the second computer system is configured to invoke an executable code corresponding to the X extension function in response to receiving the data stream, wherein the executable code is configured to:
(c) decompress the compressed image, and
(d) call a standard X internal PutImage operation to display the decompressed image on the display associated with the second computer system.

14. The communication system of claim 13, wherein said calling the X extension function invokes the execution of a client interface on the first computer system, wherein the client interface handles the transmission of the data stream to the X Server.

15. The communication system of claim 13, wherein the first computer system and second computer system are coupled through a computer network, wherein said calling the X extension function induces transfer of the data stream to the X Server through the computer network.

16. The communication system of claim 13, wherein the executable code decompresses the compressed image by calling a decompression algorithm.

17. The communication system of claim 13, wherein said executing the application further comprises:
calling the X extension function one or more additional times to induce transfer of one or more additional data streams respectively, each containing the compressed image, to one or more additional X Servers respectively, executing on one or more additional computer systems respectively.

18. The communication system of claim 17, wherein each of the remote X Servers is configured to receive the corresponding data stream, and invoke an executable code corresponding to the X extension function, wherein the executable code is configured to:
decompress the compressed image, and
call a standard X internal PutImage operation to display the decompressed image on a display associated with the corresponding additional computer.

19. The communication system of claim 13, wherein said executing the application comprises repeatedly performing (a) and (b) for a sequence of images.

20. The communication system of claim 13, wherein said executing the application further comprises generating the image.

21. A method comprising:
executing an application on a first computer system, wherein said executing comprises:
(a) compressing an image, and
(b) calling an X extension function to induce transfer of a data stream containing the compressed image to a remote X Server executing on a second computer system;
the remote X Server receiving the data stream, and invoking an executable code corresponding to the X extension function in response to receiving the data stream, wherein the executable code forwards the compressed image to a network appliance.
